(19) United States
(12) Patent Application Publication
(10) Pub. No.: US 2025/0162174 A1
(43) Pub. Date: May 22, 2025

(54) ROBOT TOOL EXCHANGE DEVICE

(71) Applicant: OGURA CLUTCH CO., LTD., Kiryu-shi (JP)

(72) Inventors: Muhammad ASYRAF, Kiryu-shi (JP); Shinichiro TANJI, Kiryu-shi (JP); Ryosuke KOBAYASHI, Kiryu-shi (JP); Ryosuke ITO, Kiryu-shi (JP)

(21) Appl. No.: 18/952,103

(22) Filed: Nov. 19, 2024

(30) Foreign Application Priority Data
Nov. 22, 2023 (JP) 2023-198267

(51) Int. Cl. B25J 15/04

(52) U.S. Cl. CPC B25J 15/0416

(57) ABSTRACT

A robot tool exchange device includes a main body portion attached to a robot arm, and a tool attachment portion to which a tool for the robot arm is attached. The main body portion includes a solenoid configured to move a plunger upward by a magnetic force of an electromagnet, a tubular wall that stores a lower portion of the plunger, a ball retractably held by the tubular wall, and a permanent magnet that moves the plunger downward and holds the plunger when the electromagnet is non-excited. When the plunger moves downward, the ball is pressed by the plunger and projects from the tubular wall. The tool attachment portion includes a frame member in which a hole to receive the tubular wall is formed. The frame member includes an engaging wall that engages with the ball projecting from the tubular wall.

### BACKGROUND OF THE INVENTION

The present invention relates to a robot tool exchange device that exchangeably attaches a tool to a robot arm.

Many industrial robots that exchange and use tools include tool exchange devices such that the tools can easily be exchanged. A conventional tool exchange device of this type is disclosed in, for example, Japanese Patent Laid-Open No. 59-175984 (reference 1). The tool exchange device disclosed in reference 1 includes a device main body attached to a robot arm, an adapter to which a tool is attached, and a connecting mechanism that disconnectably connects the adapter to the device main body.

The connecting mechanism employs a configuration that switches between connection and release between the device main body and the adapter using a movable ball. The ball is moved using an air cylinder provided in the device main body. The ball is stored in an annular groove formed in the piston rod of the air cylinder. When the piston rod retreats, the ball moves to an engaging position outside in the radial direction of the piston rod. When the piston rod advances, the ball can freely move between the engaging position and a retreat position inside in the radial direction.

When the piston rod retreats, and the ball moves to the engaging position, the adapter is connected to the device main body. When the piston rod advances, the engaged state of the ball is canceled, and the adapter can be detached from the device main body.

The air cylinder is configured such that the piston rod is advanced by an air pressure, and the piston rod is caused to retreat by the spring force of a spring member. The spring member is formed by a compression coil spring and assembled to the air cylinder in a state in which the piston rod extends through it.

In the tool exchange device disclosed in reference 1, to hold a state in which the adapter is attached to the device main body, a spring member having a large spring force needs to be used to prevent the piston rod from being advanced by vibrations or the like to cancel the engaged state of the ball. If a spring member having a large spring force is used, a large force is needed to advance the piston rod, and the piston that receives the air pressure needs to have a large diameter.

Also, in this tool exchange device, since a space to store the compression coil spring serving as the spring member needs to be formed around the piston rod, reduction of the diameter of the air cylinder is limited.

Hence, in the tool exchange device disclosed in reference 1, it is difficult to further reduce the size.

### SUMMARY OF THE INVENTION

It is an object of the present invention to provide a robot tool exchange device having a smaller size.

In order to achieve the above object of the present invention, there is provided a robot tool exchange device comprising a main body portion attached to a robot arm, and a tool attachment portion including a mounting seat to which a tool for the robot arm is attached, and detachably attached to the main body portion, wherein the main body portion includes a solenoid including an electromagnet, and a plunger configured to move toward the robot arm by a magnetic force of the electromagnet, the plunger including a first portion on a side of the robot arm and a second portion on a side of the tool attachment portion, a housing configured to store the second portion of the plunger, a ball retractably held by the housing, the ball being configured to, when the plunger moves toward the tool attachment portion, be pressed by the plunger and project from the housing, and pressing by the plunger being canceled when the plunger moves toward the robot arm, and a permanent magnet configured to move the plunger toward the tool attachment portion and hold the plunger when the electromagnet is non-excited, the tool attachment portion includes a frame member in which a hole to receive the housing is formed, and the frame member includes an engaging wall provided on a wall surface of the hole and configured to engage with the ball projecting from the housing and prevent the housing from coming off the hole.

### BRIEF DESCRIPTION OF THE DRAWINGS

FIG. 1A is a front view showing an engaged state of a robot tool exchange device according to the embodiment. FIG. 1B is a front view showing a disengaged state of the robot tool exchange device according to the embodiment.

FIGS. 2A and 2B are perspective views of the robot tool exchange device according to the embodiment.

FIG. 3 is an exploded perspective view showing accessory parts of the robot tool exchange device according to the embodiment.

FIG. 4 is a partially cutaway perspective view showing first and second frame members.

FIG. 5 is a partially cutaway perspective view showing third and fourth frame members.

FIG. 6 is a perspective sectional view of a main body portion and a tool attachment portion.

FIG. 7 is a perspective sectional view of the main body portion.

FIG. 8 is a perspective sectional view of the main body portion.

FIG. 9 is a perspective sectional view of the tool attachment portion.

FIG. 10 is a sectional view showing a part of a tubular wall in an enlarged state.

FIG. 11 is a sectional view showing a part of a fourth frame member in an enlarged state.

FIG. 12A is a sectional view showing an air passage forming member before the tool attachment portion is attached to the main body portion. FIG. 12B is a sectional view showing the air passage forming member in a state in which the tool attachment portion is attached to the main body portion.

FIG. 13 is a sectional view of the main body portion and the tool attachment portion.

FIG. 14 is a sectional view showing main parts in an enlarged state.

FIGS. 15A to 15C are sectional views showing a part of a connecting mechanism in an enlarged state.

FIG. 16 is a sectional view of a solenoid.

FIGS. 17A to 17C are sectional views for explaining the operation of the connecting mechanism.

FIG. 18 is a perspective view of the robot tool exchange device without an attachment plate and a stopper.

FIG. 19 is a sectional view showing the main body portion and the tool attachment portion so as to explain the operation of a manual release lever.

### DESCRIPTION OF THE PREFERRED EMBODIMENT

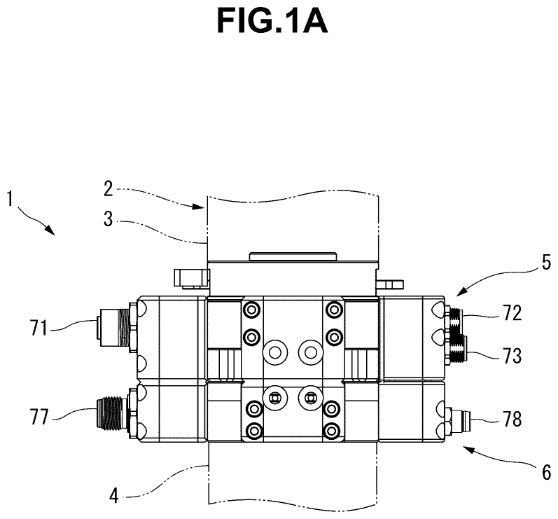

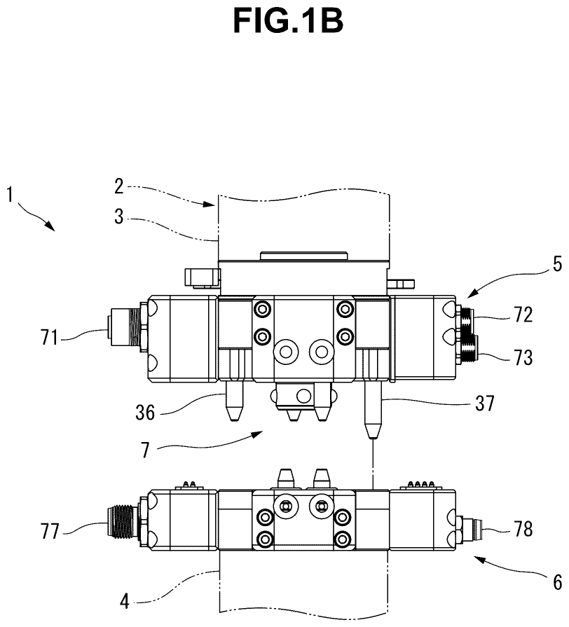

A robot tool exchange device according to an embodiment of the present invention will now be described in detail with reference to FIGS. 1 to 19.

A robot tool exchange device 1 shown in FIGS. 1A and 1B is used to exchangeably attach a robot arm tool 4 to a robot arm 3 of an industrial robot 2. The robot tool exchange device 1 includes a main body portion 5 attached to the robot arm 3, and a tool attachment portion 6 attached to the tool 4 such that it can be detached from the main body portion 5. In this embodiment, a connecting mechanism 7 (see FIG. 1B) configured to switch between contention and disconnection of the main body portion 5 and the tool attachment portion 6 is formed by the parts of the main body portion 5 and the parts of the tool attachment portion 6.

Hereinafter, when indicating a direction in a description of each constituent component of the robot tool exchange device 1, the direction in which the main body portion 5 is located with respect to the tool attachment portion 6 will be defined as “upper side”, and a reverse direction will be defined as “lower side”, as shown in FIGS. 1A and 1B. The upper side will sometimes be referred to as “one end side” or “a direction toward the robot arm 3”, and the lower side will sometimes be referred to as “the other end side” or “a direction toward the tool attachment portion 6”.

### Main Body Portion

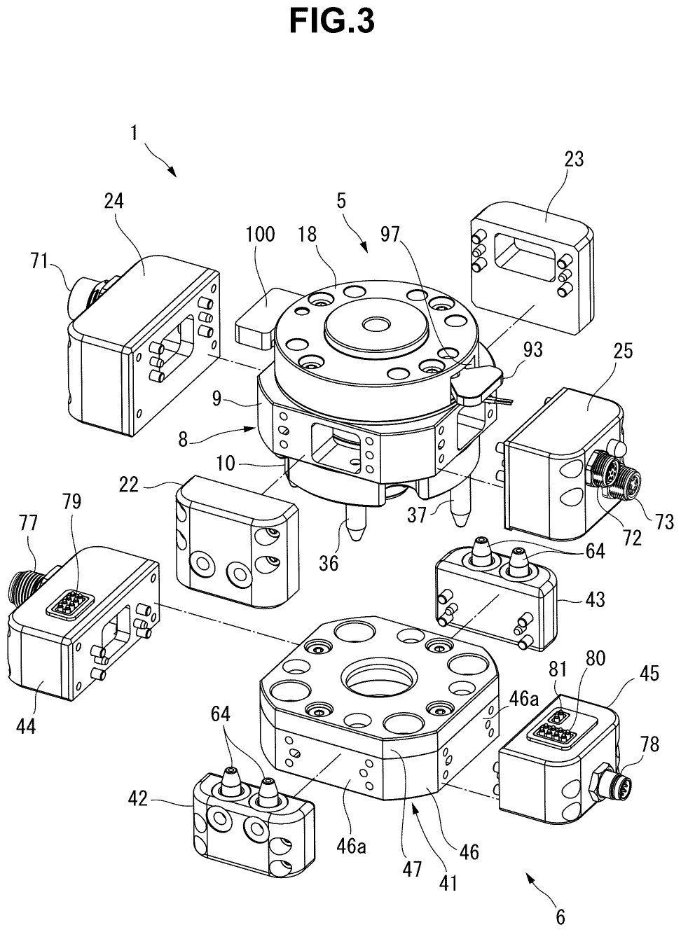

As shown in FIG. 3, the main body portion 5 is formed by assembling a plurality of functional parts (to be described later) to a main body portion side frame 8.

### First Frame Member

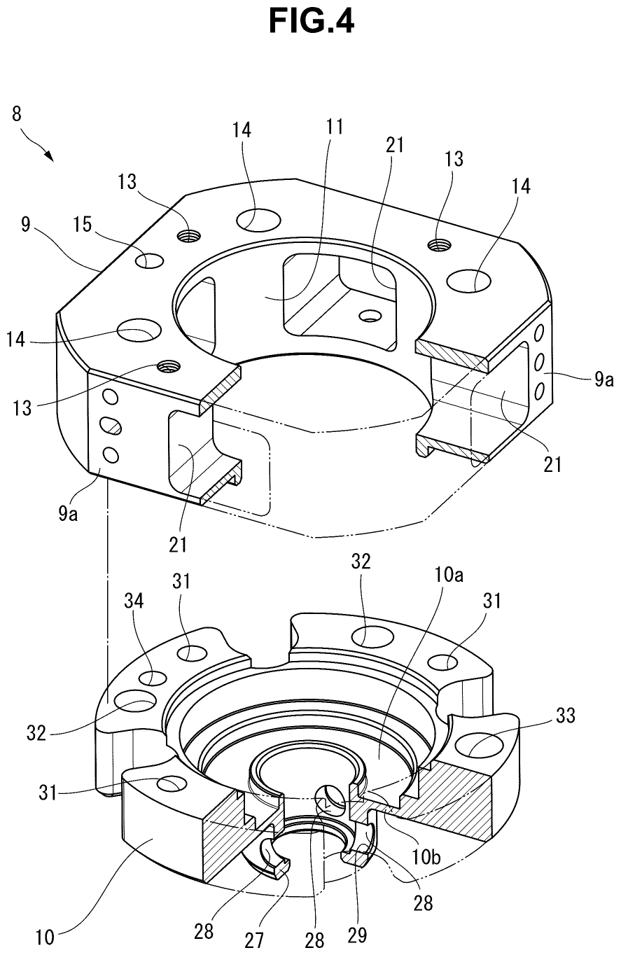

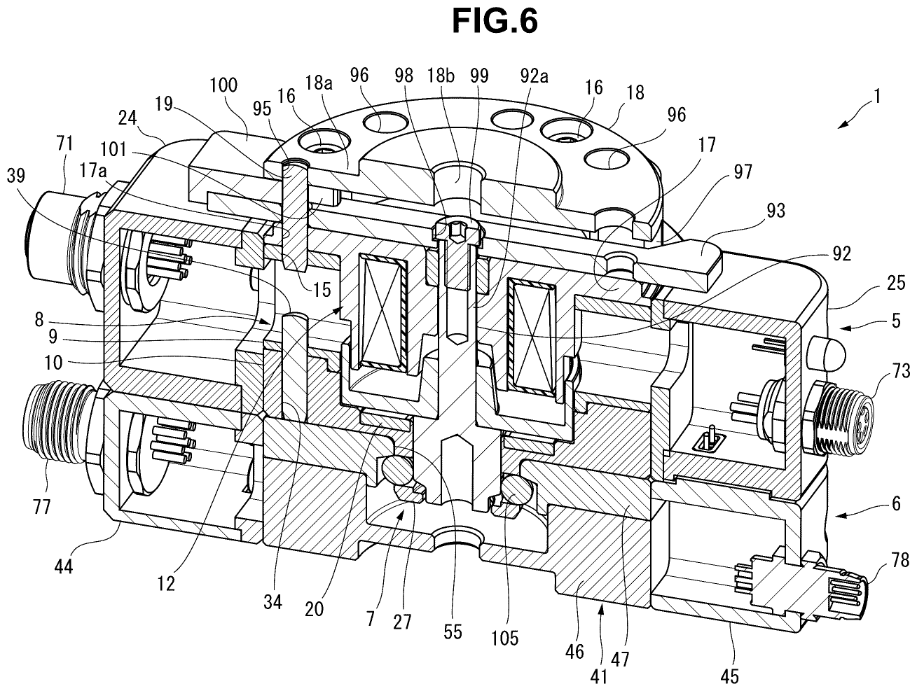

As shown in FIG. 4, the main body portion side frame 8 includes a first frame member 9 drawn on the upper side in FIG. 4, and a second frame member 10 attached to the lower surface of the first frame member 9. A first through hole 11 is formed at the center of the first frame member 9. The first through hole 11 is a hole configured to store the electromagnet portion of a solenoid 12 (see FIG. 6) to be described later, and is formed to have a circular opening shape.

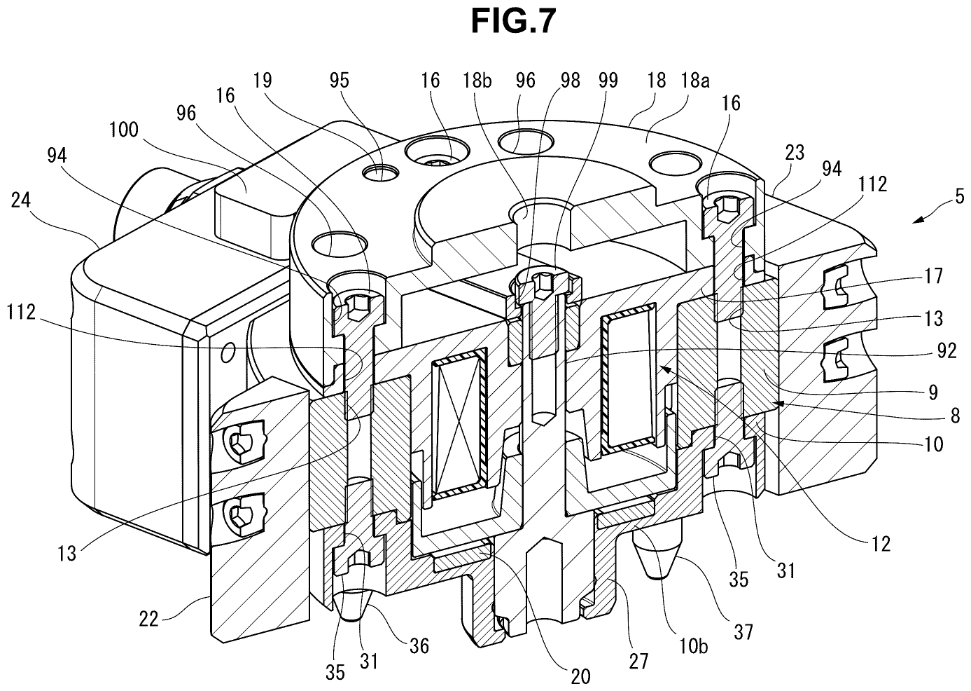

A plurality of first screw holes 13, a plurality of second through holes 14, and one third through hole 15 are formed, around the first through hole 11, in the upper surface of the first frame member 9. A first fixing bolt 16 (see FIG. 7) that fixes members overlaid on the first frame member 9 to the first frame member 9 is screwed into each first screw hole 13. The members overlaid on the first frame member 9 are a support plate 17 of the solenoid 12 (to be described later), and an attachment plate 18. The attachment plate 18 is connected to the robot arm 3.

The second through hole 14 is a hole configured to pass a fixing bolt (not shown) that fixes the main body portion 5 to the robot arm 3. The fixing bolt extends through the main body portion 5 in the vertical direction and fixes the whole main body portion 5 to the robot arm 3.

The third through hole 15 is a guide hole configured to press a guide pin 19 (see FIG. 6) to be described later into a pin hole 17a of the support plate 17. The guide pin 19 is pressed into the pin hole 17a.

Lateral holes 21 extending toward the first through hole 11 open to four side surfaces 9a of the first frame member 9. In addition, air passage forming members 22 and 23 and electronic component cases 24 and 25 shown in FIG. 3 are attached to the four side surfaces 9a of the first frame member 9. In this embodiment, of the four side surfaces 9a of the first frame member 9, the air passage forming members 22 and 23 are attached to two side surfaces 9a located to sandwich the first frame member 9, and the electronic component cases 24 and 25 are attached to the remaining two side surfaces 9a. The air passage forming members 22 and 23 and the electronic component cases 24 and 25 will be described later.

### Second Frame Member

As shown in FIG. 4, the second frame member 10 is formed into a bottomed cylindrical shape that opens upward. The second frame member 10 is made of a nonmagnetic material. As shown in FIG. 6, a permanent magnet 20 is fixed to an inner bottom surface 10a of the second frame member 10. The permanent magnet 20 forms a part of the connecting mechanism 7 to be described later, and is formed into a ring shape.

At the center of a bottom wall 10b of the second frame member 10, a cylindrical tubular wall 27 projecting downward is formed. The lower surface of the second frame member 10 except the tubular wall 27 is formed into a flat surface.

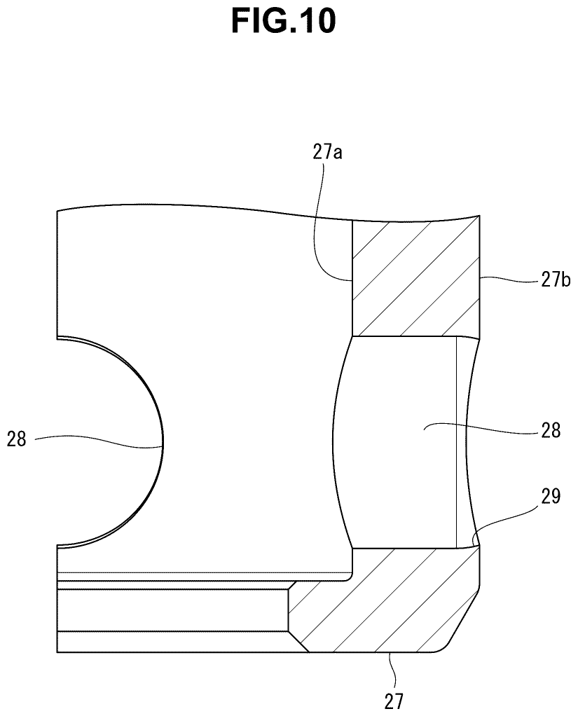

A plurality of circular through holes 28 are formed in the tubular wall 27. The through hole 28 is formed to extend through the tubular wall 27 in the radial direction. In other words, the through hole 28 extends between an inner peripheral surface 27a of the tubular wall 27 (a circumferential surface facing a columnar body 92b of a plunger 92 to be described later) and an outer peripheral surface 27b of the tubular wall 27 (a circumferential surface facing a fourth frame member 47 to be described later). As shown in FIG. 10, a tapered surface 29 whose inner diameter gradually decreases toward the opening of the outer peripheral surface 27b is formed on a portion of the through hole 28 opening to the outer peripheral surface 27b of the tubular wall 27. In this embodiment, four through holes 28 are formed at positions equally dividing the tubular wall 27 into four parts.

As show in FIG. 4, a plurality of fourth through holes 31, a plurality of fifth through holes 32, a sixth through hole 33, and a seventh through hole 34 are formed in the outer peripheral portion of the second frame member 10. As shown in FIG. 7, the fourth through hole 31 is a hole configured to pass a second fixing bolt 35 that fixes the second frame member 10 to the first frame member 9.

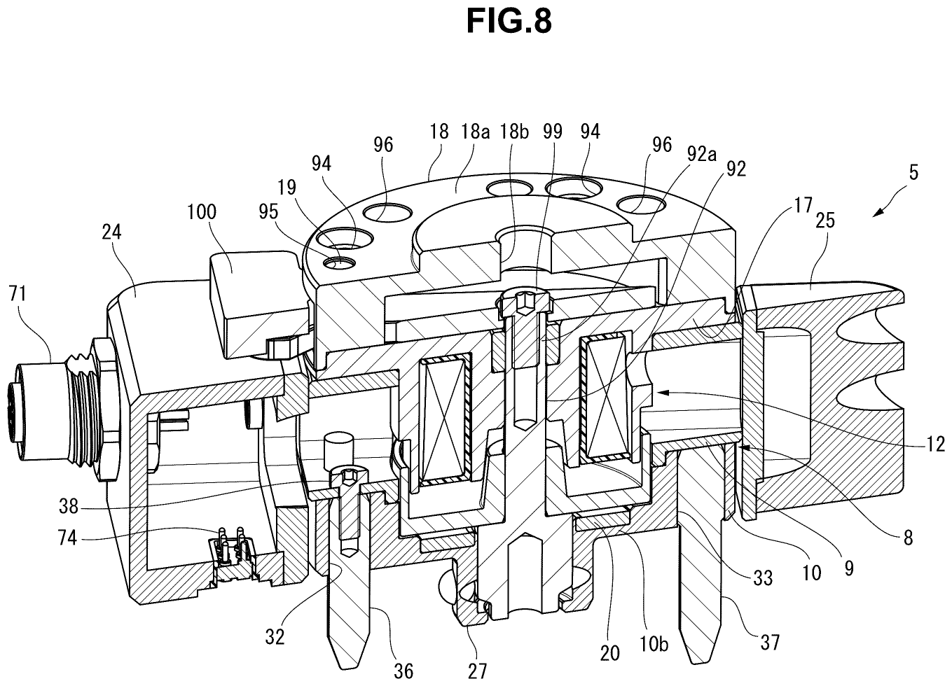

The plurality of fifth through holes 32 and the sixth through hole 33 are holes configured to pass first positioning pins 36 and a second positioning pin 37 (see FIG. 8), which position the main body portion 5 and the tool attachment portion 6 when attaching the main body portion 5 to the tool attachment portion 6. The first positioning pins 36 and the second positioning pin 37 extend through the second frame member 10 in the vertical direction and project downward from the second frame member 10. The first positioning pin 36 is inserted into the fifth through hole 32 and fixed to the first frame member 9 by a third fixing bolt 38. The second positioning pin 37 is pressed into the sixth through hole 33.

The seventh through hole 34 is a hole in which an eighth positioning pin 39 (see FIG. 6) configured to position the second frame member 10 with respect to the first frame member 9 is pressed into.

### Tool Attachment Portion

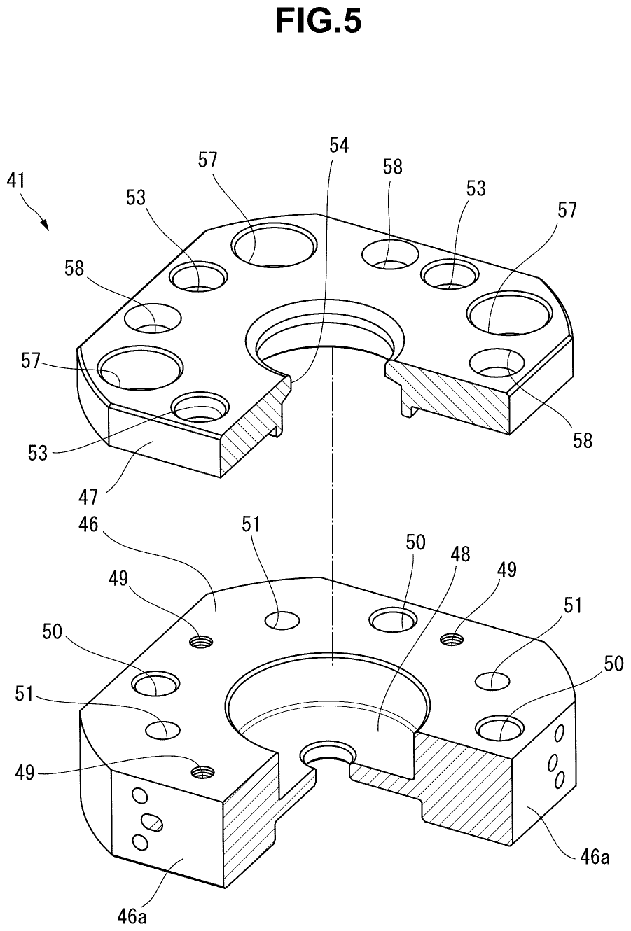

As shown in FIG. 3, the tool attachment portion 6 is formed by assembling air passage forming members 42 and 43 and electronic component cases 44 and 45 to a tool attachment portion side frame 41. As shown in FIG. 5, the tool attachment portion side frame 41 includes a third frame member 46 drawn on the lower side in FIG. 5, and a fourth frame member 47 attached on the third frame member 46.

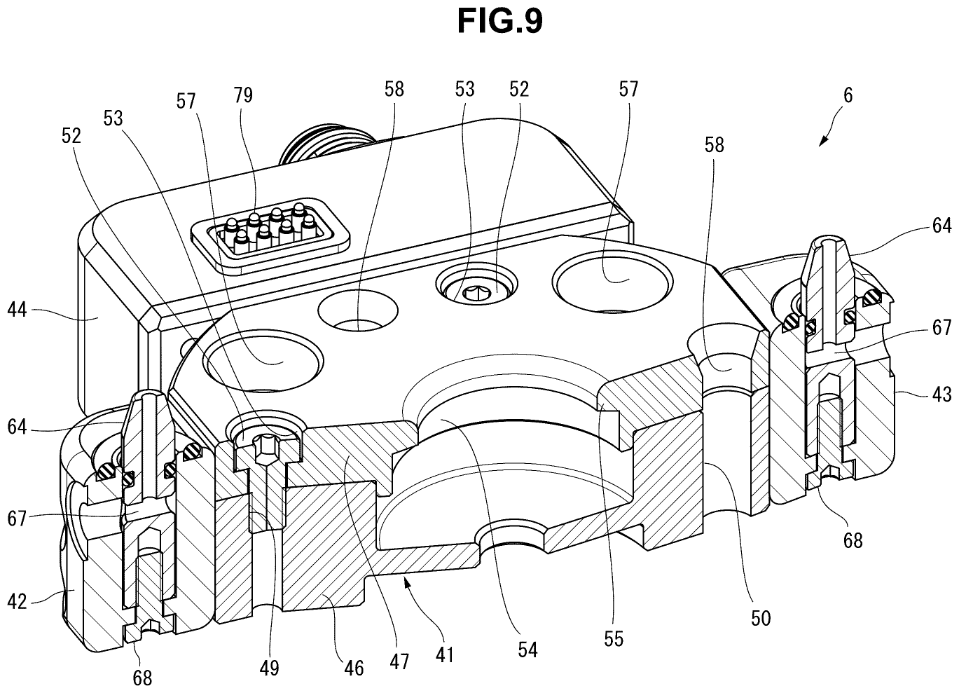

The third frame member 46 serves as a mounting seat to which the tool 4 is attached. A circular concave portion 48 opening upward is formed at the center of the third frame member 46. A plurality of second screw holes 49, a plurality of first pin holes 50, and a plurality of eighth through holes 51 are formed around the circular concave portion 48 of the third frame member 46. As shown in FIG. 9, a fourth fixing bolt 52 configured to fix the fourth frame member 47 to the third frame member 46 is screwed into the second screw hole 49. The fourth fixing bolt 52 is inserted into a ninth through hole 53 formed in the fourth frame member 47 and threadably engaged with the second screw hole 49.

The first pin holes 50 are holes in which the first positioning pins 36 and the second positioning pin 37 provided in the main body portion 5 are fitted. The eighth through hole 51 is a hole to pass a bolt (not shown) used to attach a tool to the tool attachment portion 6.

Air passage forming members 42 and 43 and electronic component cases 44 and 45 are attached to the four side surfaces of the third frame member 46. In this embodiment, of four side surfaces 46a of the third frame member 46, the air passage forming members 42 and 43 are attached to two side surfaces 46a located to sandwich the third frame member 46, and the electronic component cases 44 and 45 are attached to the remaining two side surfaces 46a.

The air passage forming members 42 and 43 of the tool attachment portion 6 are arranged at positions to be aligned with the air passage forming members 22 and 23 of the main body portion 5 in the vertical direction in a state in which the tool attachment portion 6 is attached to the main body portion 5. Also, the electronic component cases 44 and 45 of the tool attachment portion 6 are arranged at positions to be aligned with the electronic component cases 24 and 25 of the main body portion 5 in the vertical direction in a state in which the tool attachment portion 6 is attached to the main body portion 5.

As shown in FIG. 5, the upper surface of the fourth frame member 47 is formed flat such that it comes into surface contact with the lower surface of the second frame member 10 in a state in which the tool attachment portion 6 is attached to the main body portion 5.

A circular hole 54 is formed at the center of the fourth frame member 47. The circular hole 54 is formed such that the tubular wall 27 projecting from the second frame member 10 can be fitted in it. When attaching the tool attachment portion 6 to the main body portion 5, the tubular wall 27 is fitted in the circular hole 54.

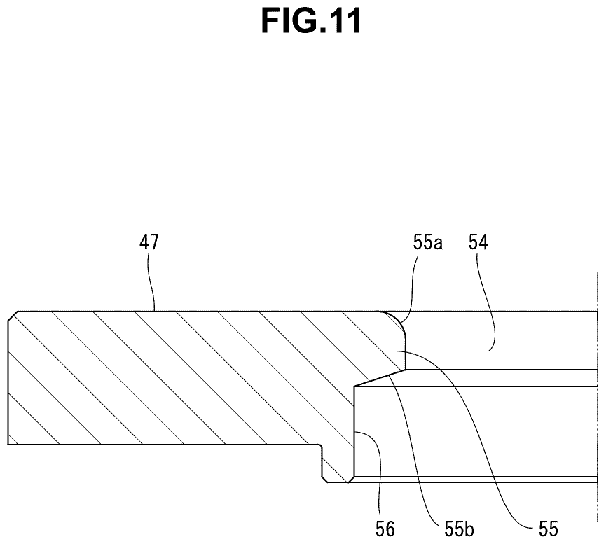

As shown in FIG. 11, the opening edge portion of the circular hole 54 on the upper side is formed by an engaging wall 55 that has a mountain-shaped section and is provided on the wall surface of the hole 54 such that it projects toward the center of the hole 54 in the radial direction. The wall surface of the engaging wall 55 on the upper side is formed by a convex curved surface 55a that has an arc-shaped section and projects toward the inside of the hole 54. The wall surface of the engaging wall 55 on the lower side is formed by a tilting surface 55b that gradually tilts, toward the center (radial center) of the hole 54 in the radial direction, to the opening edge of the hole 54 (upward). The opening portion of the circular hole 54 on the lower side, that is, a portion on the lower side of the engaging wall 55 is formed by a large-diameter hole 56 having a larger hole diameter than the opening portion on the upper side.

As shown in FIG. 5, the above-described ninth through holes 53, 10th through holes 57, and a plurality of second pin holes 58 are formed around the circular hole 54 in the fourth frame member 47. The 10th through hole 57 is a hole to pass a bolt (not shown) configured to attach the tool 4 to the tool attachment portion 6. The bolt is passed through the eighth through hole 51 of the third frame member 46 and the 10th through hole 57 of the fourth frame member 47.

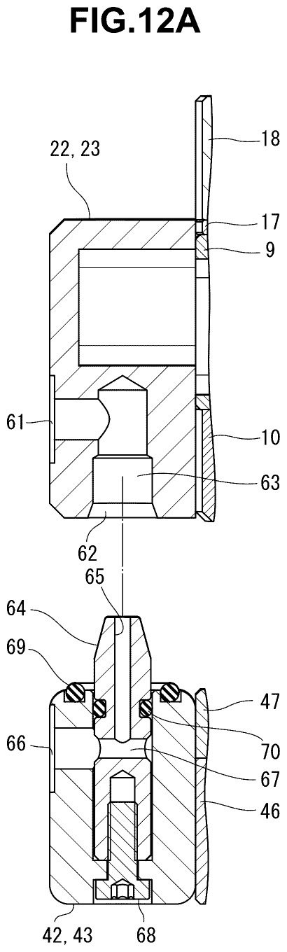

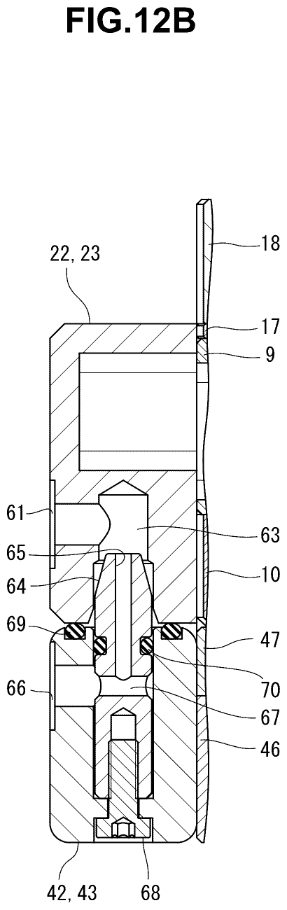

The air passage forming members 22, 23, 42, and 43 attached to the main body portion 5 and the tool attachment portion 6 supply driving air to the tool 4. As shown in FIG. 12A, in each of the air passage forming members 22 and 23 of the main body portion 5, an upstream-side air passage 63 that extends from a supply port 61 opening to a side surface to a connection port 62 opening to the lower surface is formed. An air hose (not shown) extending from the robot arm 3 is connected to the supply port 61, and tool driving air is supplied.

On the other hand, in each to the air passage forming members 42 and 43 of the tool attachment portion 6, a pin 64 projecting upward, and a downstream-side air passage 67 that extends from a passage hole 65 opening to the distal end of the pin 64 to an air outlet 66 opening to a side surface of the air passage forming member 42 or 43 is formed. The pin 64 is fixed to each of the air passage forming members 42 and 43 of the tool attachment portion 6 by a fifth fixing bolt 68. Also, as shown in FIG. 12B, the pin 64 is inserted from the lower side into the connection port 62 of the main body portion 5 in a state in which the tool attachment portion 6 is attached to the main body portion 5. An air hose (not shown) configured to supply driving air to the tool 4 is connected to the air outlet 66.

For this reason, when the tool attachment portion 6 is attached to the main body portion 5, the driving air is supplied to the tool 4 by an air supply system of the air hose on the side of the robot arm 3→the air passages 63 and 67→the air hose on the tool side. On each of the end faces of the air passage forming members 42 and 43 of the tool attachment portion 6 facing the air passage forming members 22 and 23 of the main body portion 5, a seal member 69 configured to prevent air from leaking from the mating surfaces between the air passage forming members 22 and 23 and the air passage forming members 42 and 43 is attached around each pin 64. In addition, a seal member 70 configured to do sealing between the air passage forming members 22, 23, 42, and 43 is attached to each pin 64.

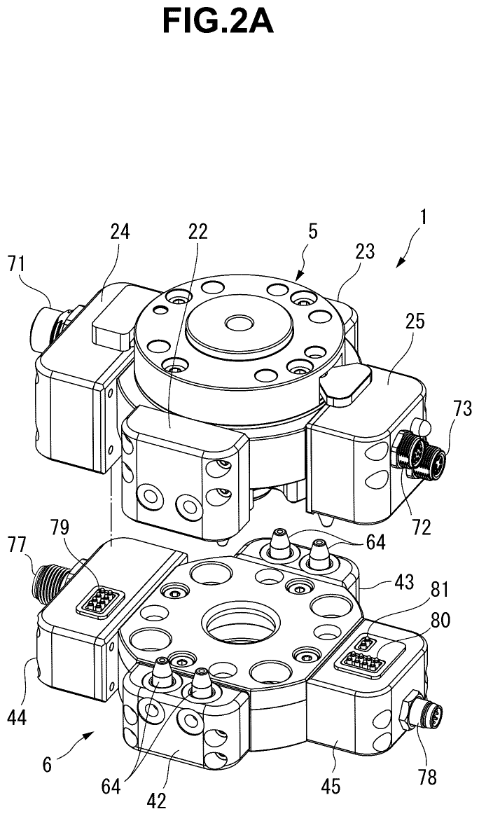

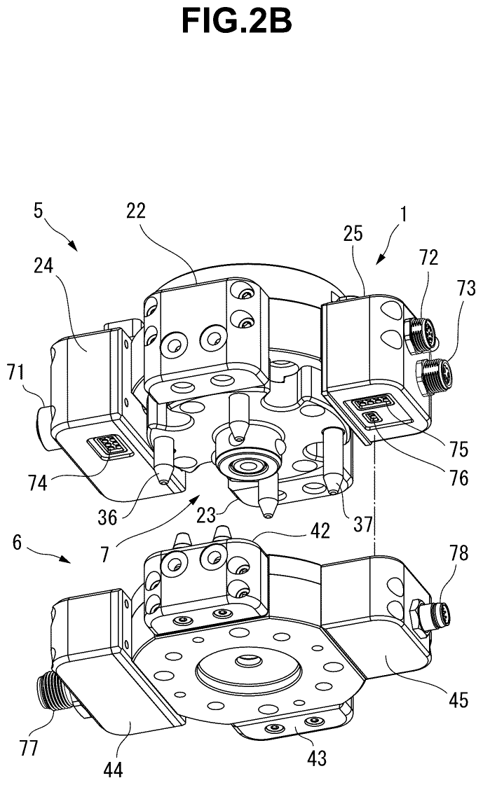

The electronic component cases 24 and 25 of the main body portion 5 support main body portion side cable joints 71 to 73 (see FIGS. 2A, 2B, 6, and 8) and main body portion side connectors 74 to 76 (see FIGS. 2B and 8). Note that in FIGS. 6 and 8, wirings in the electronic component cases 24, 25, 44, and 45 are not illustrated.

Feed/control cables (not shown) extending from the robot arm 3 are detachably connected to the main body portion side cable joints 71 to 73, and the main body portion side cable joints 71 to 73 are electrically connected to electronic components such as the solenoid 12 (to be described later) and the main body portion side connectors 74 to 76 in the main body portion 5. The electronic component cases 44 and 45 of the tool attachment portion 6 support tool attachment portion side cable joints 77 and 78 and tool attachment portion side connectors 79 to 81. Cables (not shown) connected to the tool 4 are detachably connected to the tool attachment portion side cable joints 77 and 78, and the tool attachment portion side cable joints 77 and 78 are electrically connected to the tool attachment portion side connectors 79 to 81. The tool attachment portion side connectors 79 to 81 are configured to be connected to the main body portion side connectors 74 to 76 by attaching the tool attachment portion 6 to the main body portion 5.

Hence, when the tool attachment portion 6 is attached to the main body portion 5, the robot arm 3 and the tool 4 are electrically connected via a circuit formed by the feed/control cables on the side of the robot arm 3→the main body portion side cable joints 71 to 73→the main body portion side connectors 74 to 76→the tool attachment portion side connectors 79 to 81→the tool attachment portion side cable joints 77 and 78→the cables on the side of the tool 4.

### Connecting Mechanism

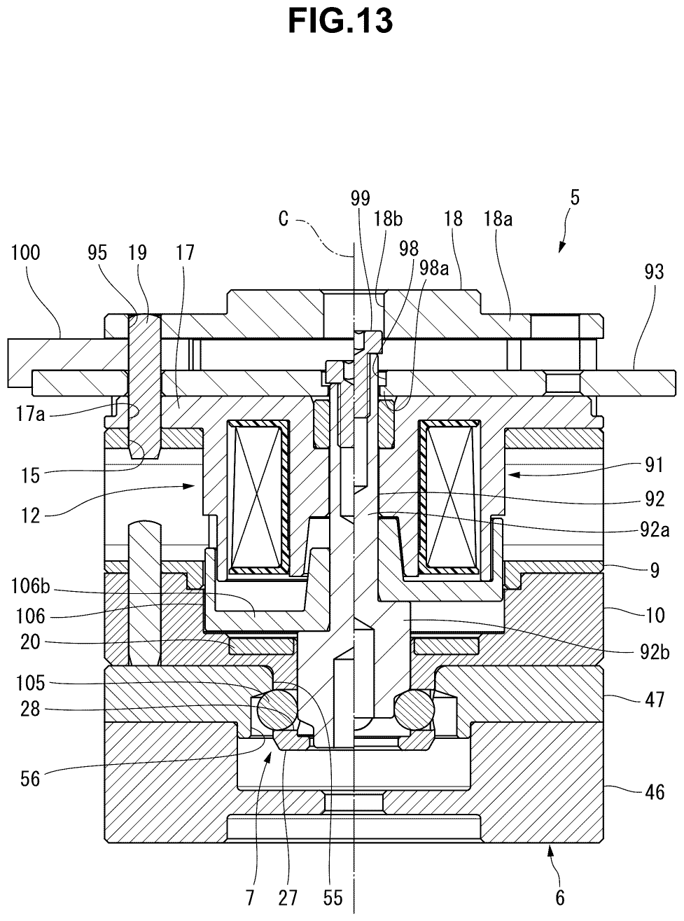

As shown in FIG. 13, the connecting mechanism 7 is configured to operate using the solenoid 12 stored in the main body portion 5 as a main power source. A state in which the solenoid 12 is OFF (non-energized) is shown on the left side of a center line C in FIG. 13, and a state in which the solenoid 12 is ON is shown on the right side of the center line C.

The solenoid 12 employs a structure in which the plunger 92 is movably supported in the axis center of an electromagnet 91 formed in to a cylindrical shape. The solenoid 12 according to this embodiment is configured such that the plunger 92 is moved to one end side (the upper side in FIG. 13), that is, toward the robot arm 3 by the magnetic force of the electromagnet 91.

One end side of the plunger 92 (a first portion on the side of the robot arm 3) is formed by a columnar lock pin 92a, and the other end side of the plunger 92 (a second portion on the side of the tool attachment portion 6) is formed by a columnar body 92b whose outer diameter is larger than the lock pin 92a. A manual release lever 93 is connected to the distal end portion of the lock pin 92a (the end portion on one end side of the plunger 92), as shown in FIG. 6. The manual release lever 93 is operated by an operator (not shown) to manually cancel connection of the connecting mechanism 7. The manual release lever 93 according to this embodiment is formed into a plate shape extending in a direction orthogonal to the longitudinal direction (vertical direction) of the plunger 92 and arranged on the solenoid 12 while crossing the attachment plate 18 in the radial direction.

As shown in FIG. 7, the attachment plate 18 is formed into a bottomed cylindrical shape that opens downward, and its outer peripheral portion is overlaid on the support plate 17 of the solenoid 12. A center hole 18b having a circular opening shape is formed at the center of a sealing plate 18a. In the outer peripheral portion of the attachment plate 18, 11th through holes 94 each configured to pass the first fixing bolt 16, a 12th through hole 95 in which the guide pin 19 (see FIG. 6) is fitted, and 13th through holes 96 each configured to pass a fixing bolt (not shown) that fixes the main body portion 5 to the robot arm 3 are formed. In addition, a notch 97 (see FIGS. 3 and 6) configured to pass the manual release lever 93 is formed in the outer peripheral portion of the attachment plate 18.

The moving direction of the manual release lever 93 is limited only to the vertical direction by the guide pin 19 extending through the attachment plate 18. The connecting portion between the manual release lever 93 and the lock pin 92a employs a structure in which the distal end portion of the lock pin 92a is inserted, in a loosely fitted state, into a 14th stepped through hole 98 formed in the manual release lever 93, and the manual release lever 93 is locked by a bolt 99 threadably engaged with the distal end of the lock pin 92a. Note that the bolt 99 forms a coupling member connected to the distal end portion of the lock pin 92a.

As shown in FIG. 13, in the 14th stepped through hole 98, the hole diameter on one end side that is the upper side in FIG. 13 is made larger than that on the other end side, thereby forming a step portion 98a on the other end side close to the support plate 17. The step portion 98a is formed to project inward in the radial direction. The hole diameter (inner diameter) of the 14th stepped through hole 98 is larger than the outer diameter of the lock pin 92a. The outer diameter of the head portion of the bolt 99 is larger than the hole diameter of the step portion 98a and smaller than the hole diameter on the upper side of the step portion 98a of the 14th stepped through hole 98.

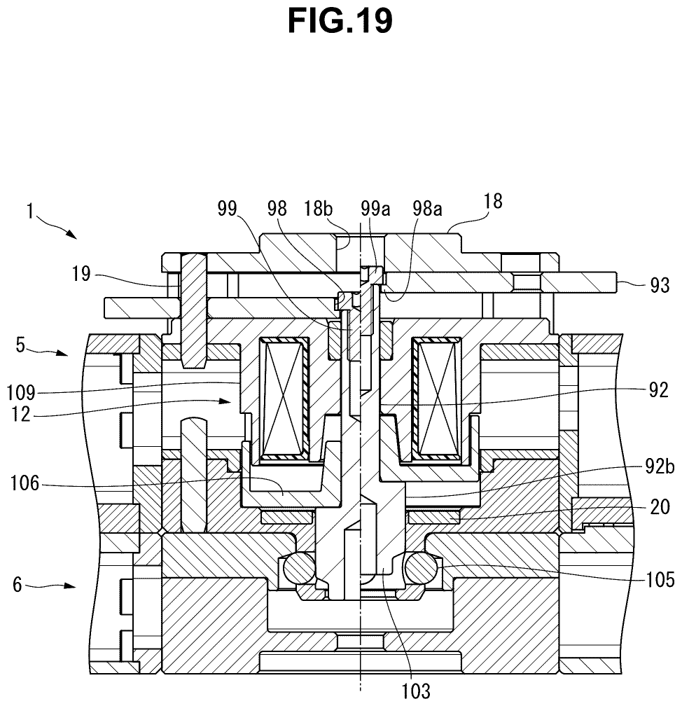

According to the locking structure formed by the 14th stepped through hole 98 and the bolt 99, only the lock pin 92a can be moved upward (that is, toward the robot arm 3) in a state in which the manual release lever 93 is placed on the solenoid 12. Also, as shown in FIG. 19, when the manual release lever 93 is pulled up, the step portion 98a of the 14th stepped through hole 98 abuts against a head portion 99a of the bolt 99, and the lock pin 92a is pulled up integrally with the manual release lever 93. When pulling up the manual release lever 93, the head portion 99a of the bolt 99 is inserted into the center hole 18b of the attachment plate 18.

As shown in FIG. 6, a stopper 100 is provided between the manual release lever 93 and the sealing plate 18a of the attachment plate 18 to impede movement of the manual release lever 93 when the manual release lever 93 is not used. The stopper 100 includes a slit 101 in which the guide pin 19 is inserted, and is sandwiched in a detachable state between the manual release lever 93 and the sealing plate 18a of the attachment plate 18.

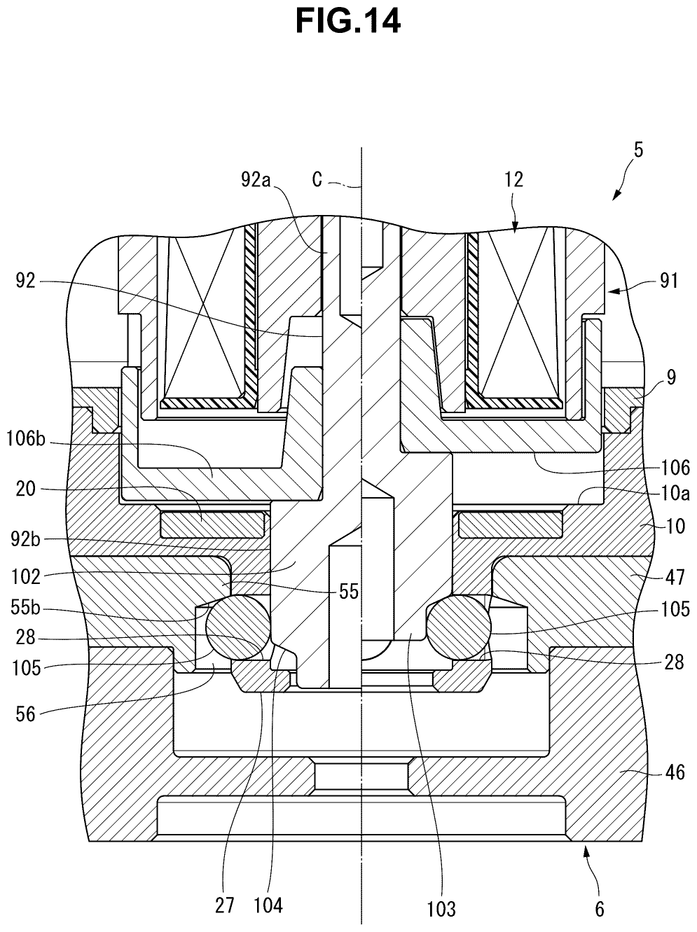

As shown in FIG. 14, the columnar body 92b located at the lower end portion of the plunger 92 includes a large-diameter portion 102 connected to the lock pin 92a and a small-diameter portion 103 connected to the lower end portion of the large-diameter portion 102. The large-diameter portion 102 is formed into such a shape that is fitted in the tubular wall 27 of the second frame member 10 and stored inside the tubular wall 27. The tubular wall 27 forms a housing that stores the columnar body 92b of the plunger 92.

The small-diameter portion 103 has an outer diameter smaller than the outer diameter of the large-diameter portion 102. A tapered surface 104 whose outer diameter gradually becomes large toward the upper side (that is, from the small-diameter portion 103 to the large-diameter portion 102) is formed between the large-diameter portion 102 and the small-diameter portion 103. The small-diameter portion 103 is formed to be adjacent to the through holes 28 of the tubular wall 27 in the radial direction of the tubular wall 27 in a state in which the plunger 92 moves upward with respect to the electromagnet 91, as shown on the right side of the center line C in FIG. 14.

A ball 105 that forms a part of the connecting mechanism 7 is stored in each of the four through holes 28 of the tubular wall 27. The balls 105 can be stored in the through holes 28 in a state in which the plunger 92 moves upward (that is, toward the robot arm 3), as shown on the right side of the center line C in FIG. 14. Also, the balls 105 are pushed outward in the radial direction of the tubular wall 27 by the tapered surface 104 and the large-diameter portion 102 in a state in which the plunger 92 moves downward with respect to the electromagnet 91 (that is, toward the tool attachment portion 6), as shown on the left side of the center line C in FIG. 14. In a state in which the plunger 92 is located at the lowermost position, the balls 105 partially project from the tubular wall 27. At this time, the ball 105 is brought into contact with the tapered surface 29 formed on the opening portion of the through hole 28 and held in the through hole 28 in a state in which it does not fall out of the through hole 28. That is, the ball 105 is retractably held in the tubular wall 27. In other words, the through hole 28 formed in the tubular wall 27 forms a ball holding portion that retractably holds the ball 105.

The position of the plunger 92 shown on the right side of FIG. 14, that is, the position of the plunger 92 at which the small-diameter portion 103 is located adjacent to the through holes 28, and the balls 105 can wholly be stored in the through holes 28 will be referred to as a “release position” hereinafter. Also, the position of the plunger 92 shown on the left side of FIG. 14, that is, the position of the plunger 92 at which the balls 105 are pushed by the large-diameter portion 102 and project out of the tubular wall 27 will be referred to as a “lock position”.

As shown in FIG. 13, in a state in which the tool attachment portion 6 is attached to the main body portion 5, the through holes 28 and the balls 105 are located at the same position as the large-diameter hole 56 of the fourth frame member 47 in the vertical direction. For this reason, when the plunger 92 moves to the lock position in this state, the ball 105 is inserted into the large-diameter hole 56 of the fourth frame member 47, as shown on the left side of the center line C in FIG. 13. In the lock state, since the balls 105 engage with the engaging wall 55, the tool attachment portion 6 cannot be detached from the main body portion 5.

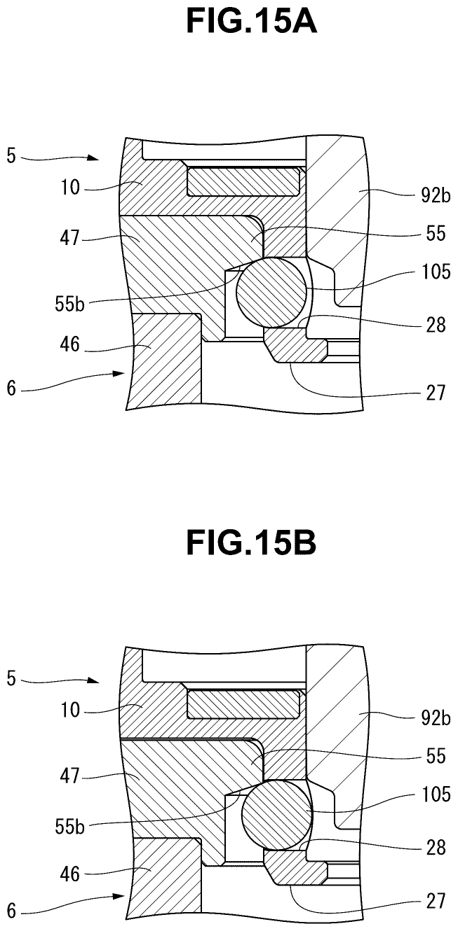

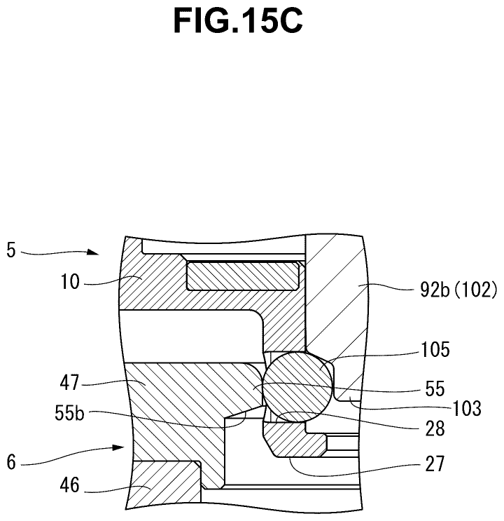

When the plunger 92 moves from this state to the release position, as shown in FIG. 15A, nothing pushes the balls 105 outward in the radial direction of the tubular wall 27 anymore. That is, in this state, the pressing of the balls 105 by the plunger 92 is canceled. If, in this state, the main body portion 5 is moved in a direction of separating from the tool attachment portion 6, as shown in FIG. 15B, the balls 105 are pressed by the tilting surface 55b of the fourth frame member 47 and pushed into the tubular wall 27. When the main body portion 5 is further separated from the tool attachment portion 6, the engaged state between the engaging wall 55 and the balls 105 is canceled, as shown in FIG. 15C, and the tool attachment portion 6 can be detached from the main body portion 5.

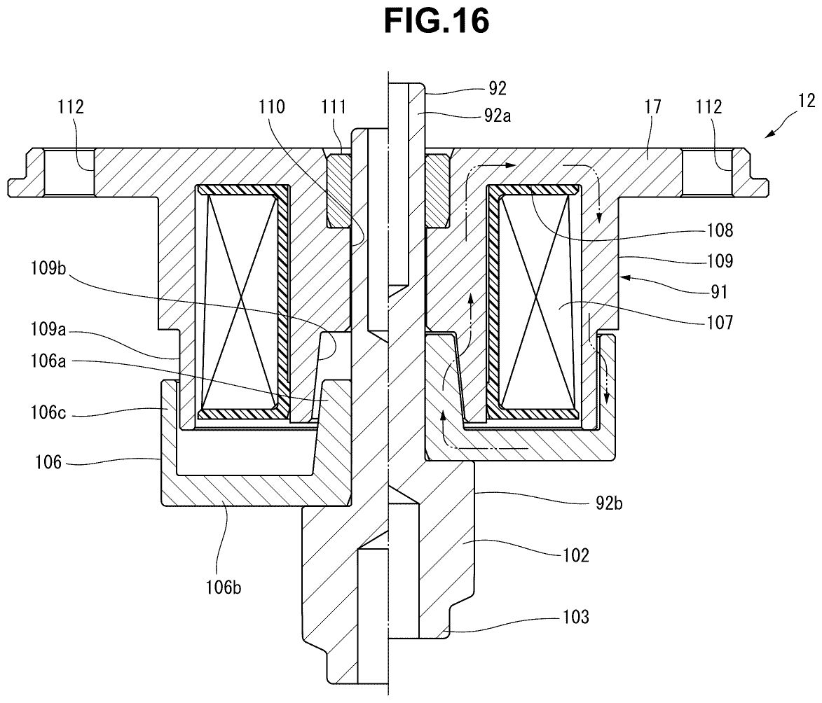

As shown in FIG. 16, an armature 106 having a bottomed cylindrical shape is fixed, in a state in which it is located on the same axis as the plunger 92, to the center of the plunger 92 in the axial direction. The armature 106 according to this embodiment includes an inner cylindrical portion 106a through which the lock pin 92a of the plunger 92 extends, a disc-shaped attracting portion 106b extending outward from the lower end of the inner cylindrical portion 106a in the radial direction, and an outer cylindrical portion 106c extending upward from the outer peripheral portion of the attracting portion 106b. The armature 106 is formed into such a size that can be stored inside the second frame member 10.

The permanent magnet 20 provided on the inner bottom portion of the second frame member 10 is arranged at a position facing the attracting portion 106b of the armature 106, as shown in FIG. 14. Hence, the magnetic force of the permanent magnet 20 acts on the armature 106 stored inside the second frame member 10.

In a state in which no magnetic force other than the magnetic force of the permanent magnet 20 acts on the armature 106 (a state in which the electromagnet 91 of the solenoid 12 is non-excited), as shown in FIG. 14, the armature 106 is attracted to the inner bottom surface 10a of the second frame member 10 by the magnetic force of the permanent magnet 20. When the armature 106 is attracted to the inner bottom surface 10a of the second frame member 10, the plunger 92 moves to the lower side (that is, toward the tool attachment portion 6) and is held by the permanent magnet 20.

In the solenoid 12 according to this embodiment, the armature 106 is attracted to the inner bottom surface 10a of the second frame member 10 by the magnetic force of the permanent magnet 20, and the plunger 92 is located at the above-described lock position, as shown on the left side of the center line C in FIG. 14. In this state, the permanent magnet 20 magnetically holds the plunger 92 moved to make the balls 105 project from the tubular wall 27.

As shown in FIG. 16, the electromagnet 91 includes a cylindrical field core 109 having an annular groove 108 that stores a cylindrical electromagnetic coil 107, and the support plate 17 extending outward from the upper end of the field core 109 in the radial direction. The annular groove 108 of the field core 109 opens toward the armature 106. A shaft hole 110 extending in the vertical direction is formed in the axis center of the field core 109. The lock pin 92a of the plunger 92 is inserted into the shaft hole 110 and supported by a bearing member 111 provided at the upper end portion of the shaft hole 110 so as to be movable in the vertical direction.

As shown in FIGS. 6 and 7, the support plate 17 is fixed to the first frame member 9 by the first fixing bolts 16 (see FIG. 7) and the guide pin 19 (see FIG. 6) in a state in which it is sandwiched between the first frame member 9 and the attachment plate 18. The guide pin 19 is pressed into the pin hole 17a of the support plate 17 and fitted in the third through hole 15 of the first frame member 9. The first fixing bolts 16 are passed through 15th through holes 112 formed in the support plate 17 and threadably engaged with the first screw holes 13 of the first frame member 9.

A small-diameter portion 109a inserted inside the outer cylindrical portion 106c of the armature 106 is formed on the outer peripheral portion on the lower end side of the field core 109 according to this embodiment. A gap capable of passing the magnetic flux of the electromagnetic coil 107 is formed between the outer peripheral surface of the small-diameter portion 109a and the inner peripheral surface of the outer cylindrical portion 106c.

A circular hole 109b opening to the lower side is formed in the inner peripheral portion at the lower end portion of the field core 109. The hole 109b is formed to be able to receive the inner cylindrical portion 106a of the armature 106. The inner peripheral surface of the hole 109b and the outer peripheral surface of the inner cylindrical portion 106a of the armature 106 gradually tilt, toward the upper side, inward in the radial direction. A gap capable of passing the magnetic flux of the electromagnetic coil 107 is formed between the inner peripheral surface of the hole 109b and the outer peripheral surface of the inner cylindrical portion 106a.

When the electromagnetic coil 107 of the electromagnet 91 is energized, and the electromagnet 91 is excited, the field core 109 and the armature 106 form a magnetic path, the magnetic flux flows to the field core 109 and the armature 106, as indicated by an alternate long and two short dashed line in FIG. 16, and a magnetic attraction force acts to the armature 106 in a direction of pulling up the armature 106. The electromagnet 91 generates a magnetic attraction force such that the armature 106 that is attracted to the third frame member 46 by the magnetic force of the permanent magnet 20 is pulled up against the magnetic attraction force of the permanent magnet 20. Hence, when the electromagnet 91 is excited, the armature 106 is attracted to the field core 109 by the magnetic force, and the field core 109 is closed by the armature 106, as shown on the right side of the center line C in FIG. 16. When the armature 106 is attracted to the field core 109 by the magnetic force, the plunger 92 is located at the release position, as shown on the right side of the center line C in FIG. 13.

### Operation

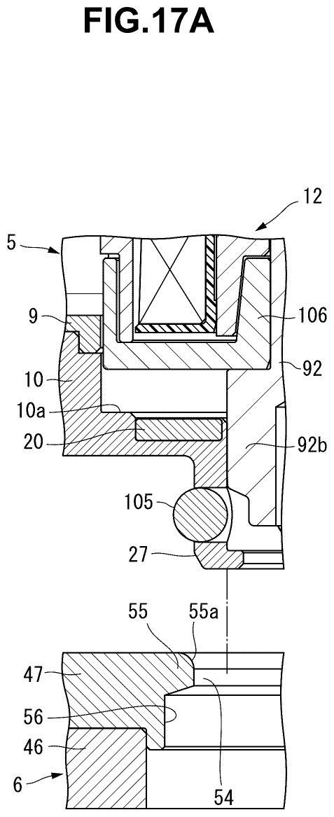

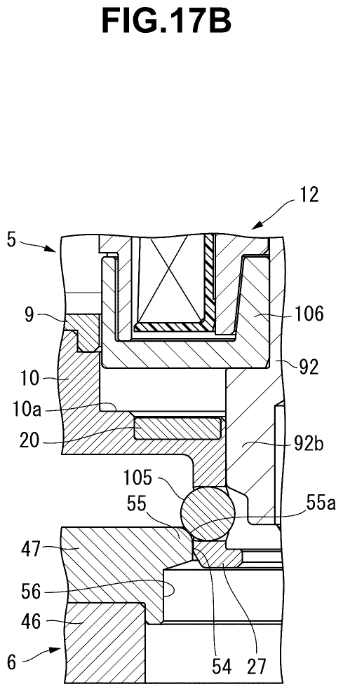

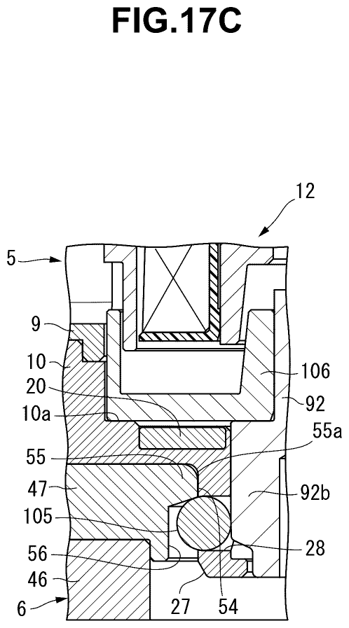

To attach the tool 4 to the robot arm 3 using the thus configured robot tool exchange device 1, first, as shown in FIG. 17A, the solenoid 12 of the main body portion 5 is energized to move the plunger 92 to the release position. Then, the robot arm 3 is operated to move the main body portion 5 close to the tool attachment portion 6, and the tubular wall 27 of the main body portion 5 is inserted into the hole 54 of the tool attachment portion 6, as shown in FIG. 17B. At this time, if the balls 105 project from the tubular wall 27, the balls 105 contact the convex curved surface 55a of the engaging wall 55 and are thus pressed into the tubular wall 27.

Next, in a state in which the tubular wall 27 is inserted into the hole 54, and the second frame member 10 is overlaid on the fourth frame member 47, feed to the solenoid 12 is stopped. If the solenoid 12 loses the magnetic force, the armature 106 is attracted to the side of the inner bottom surface 10a of the second frame member 10 by the magnetic attraction force of the permanent magnet 20. As shown in FIG. 17C, the armature 106 is attracted to the second frame member 10 by the magnetic attraction force of the permanent magnet 20. As a result, the plunger 92 moves to the other end side and is held by the permanent magnet 20.

At this time, the columnar body 92b of the plunger 92 moves downward in the tubular wall 27, and the balls 105 are pressed by the columnar body 92b along with the movement and project from the tubular wall 27. The balls 105 are inserted into the large-diameter hole 56 of the fourth frame member 47. When the balls 105 are inserted into the large-diameter hole 56, the balls 105 engage with the engaging wall 55, and the main body portion 5 cannot be detached upward from the tool attachment portion 6. A work using the tool 4 is executed in a locked state in which the main body portion 5 and the tool attachment portion 6 are integrated.

To detach the tool 4 from the tool attachment portion 6, the robot arm 3 is operated to place the tool attachment portion 6 on a support table (not shown), and the solenoid 12 is energized in this state. When the solenoid 12 is energized, the magnetic attraction force of the electromagnet 91 acts on the armature 106, and the armature 106 is attracted to the field core 109 against the magnetic attraction force of the permanent magnet 20. When the armature 106 is attracted to the field core 109, as shown in FIG. 15A, the columnar body 92b of the plunger 92 moves upward in the tubular wall 27 to set the balls 105 in a movable state.

The robot arm 3 is then operate to move the main body portion 5 up. When the main body portion 5 moves to the upper side with respect to the tool attachment portion 6, the balls 105 are pressed against the tilting surface 55b of the engaging wall 55 and pushed into the tubular wall 27, as shown in FIG. 15B, and the engaged state between the balls 105 and the engaging wall 55 is canceled. Hence, when the main body portion 5 is moved up in an ON state of the solenoid 12, as shown in FIG. 15C, the main body portion 5 is detached above from the tool attachment portion 6.

### Method of Manually Performing Detachment

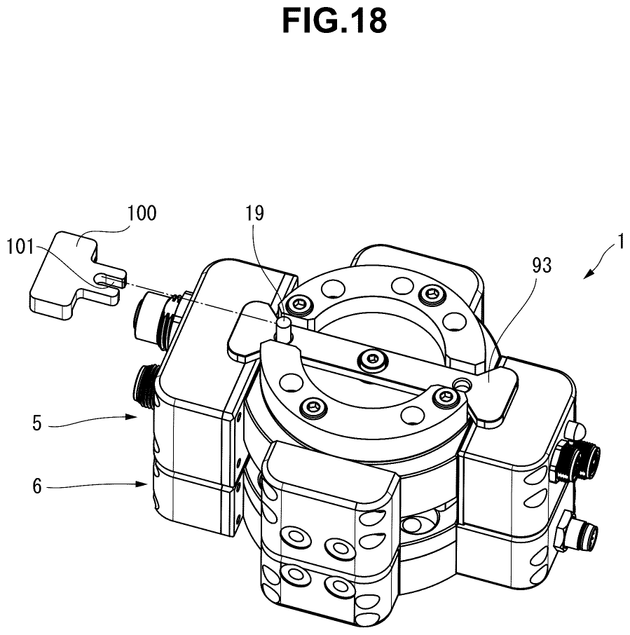

In the robot tool exchange device 1 according to this embodiment, the operation of detaching the main body portion 5 from the tool attachment portion 6 can be performed manually without energizing the solenoid 12. To manually detach the main body portion 5 from the tool attachment portion 6, first, the stopper 100 is detached, as shown in FIG. 18, and the manual release lever 93 is pulled upward with respect to the solenoid 12, as shown on the right side of the center line C in FIG. 19. When the lever 93 is operated in this manner, the plunger 92 moves upward together with the lever 93, the small-diameter portion 103 of the columnar body 92b is located adjacent to the balls 105, and the balls 105 can freely move. When the main body portion 5 is moved upward with respect to the tool attachment portion 6 in this state, as shown in FIG. 15C, the main body portion 5 can be detached from the tool attachment portion 6.

Also, in a state in which the manual release lever 93 is operated to move the plunger 92 such that the armature 106 comes into contact with the field core 109, the main body portion 5 can be attached to the tool attachment portion 6 without energizing the solenoid 12. That is, according to the robot tool exchange device 1, it is possible to manually detach the main body portion 5 from the tool attachment portion 6 or manually attach the main body portion 5 to the tool attachment portion 6.

### Effects of Embodiment

The robot tool exchange device 1 according to this embodiment employs a configuration in which a lock state of the main body portion 5 attached to the tool attachment portion 6 is held by the magnetic attraction force of the permanent magnet 20. For this reason, as compared to a case where a compression coil spring is used to maintain the lock state, the structure for holding the lock state can be made small. Hence, according to this embodiment, it is possible to provide a robot tool exchange device having a smaller size.

The engaging wall 55 of the fourth frame member 47 according to this embodiment includes the tilting surface 55b that contacts the balls 105. The tilting surface 55b gradually tilts, toward the radial center of the hole 54 of the fourth frame member 47, to the opening edge of the hole 54. Hence, since the balls 105 can be pressed by the tilting surface 55b and pushed into the tubular wall 27 when detaching the main body portion 5 from the tool attachment portion 6, no special operation need to be performed to cancel the lock state.

The columnar body 92b (second portion) of the plunger 92 according to this embodiment includes the large-diameter portion 102 connected to the lock pin 92a (first portion) of the plunger 92, the small-diameter portion 103 having an outer diameter smaller than the outer diameter of the large-diameter portion 102, and the tapered surface 104 disposed between the large-diameter portion 102 and the small-diameter portion 103 and having an outer diameter that gradually becomes large from the small-diameter portion 103 to the large-diameter portion 102. When the plunger 92 moves toward the tool attachment portion 6, the balls 105 held by the small-diameter portion 103 is pushed outward in the radial direction of the tubular wall 27 by the tapered surface 104 and the large-diameter portion 102, and the balls 105 partially project out of the tubular wall 27. For this reason, no special operation need be performed to obtain the lock state.

The tubular wall 27 (housing) according to this embodiment includes a ball holding portion configured to retractably hold the balls 105. The ball holding portion includes the through holes 28 extending between the inner peripheral surface 27a of the tubular wall 27 facing the columnar body 92b of the plunger 92 and the outer peripheral surface 27b of the tubular wall 27 facing the fourth frame member 47. The through hole 28 includes the tapered surface 29 whose inner diameter gradually decreases toward the outer peripheral surface 27b of the tubular wall 27. The ball 105 is brought into contact with the tapered surface 29 and held in the through hole 28 without falling out of the through hole 28. Hence, the ball holding portion can retractably hold the balls 105.

The electromagnet 91 according to this embodiment is formed into a cylindrical shape. The plunger 92 includes the armature 106 located on the same axis as the electromagnet 91. The permanent magnet 20 is arranged at a position facing the armature 106. Hence, since the direction in which the armature 106 can move and the direction in which the armature 106 is attracted by the magnetic attraction force of the permanent magnet 20 are parallel, the plunger 92 can reliably be held at the lock position by efficiently using the magnetic attraction force of the permanent magnet 20.

The electromagnet 91 according to this embodiment includes the cylindrical electromagnetic coil 107, and the cylindrical field core 109 including the annular groove 108 configured to open toward the armature 106 and store the electromagnetic coil 107. The armature 106 and the field core 109 form a magnetic path. When the electromagnetic coil 107 of the electromagnet 91 is energized, and the electromagnet 91 is excited, a magnetic flux flows to the field core 109 and the armature 106, and a magnetic attraction force toward the electromagnet 91 acts on the armature 106. When the armature 106 is attracted to the field core 109 by the magnetic force, the plunger 92 can be located at the release position.

The first portion of the plunger 92 according to this embodiment includes the lock pin 92a extending through the axis center of the cylindrical electromagnet 91. The main body portion 5 further includes the manual release lever 93 that is connected to the distal end portion of the lock pin 92a and configured to move the lock pin 92a toward the robot arm 3. Hence, by operating the manual release lever 93, it is possible to switch between the lock state and the release state without energizing the solenoid 12.

The connecting portion between the lever 93 and the lock pin 92a includes the through hole 98 formed in the lever 93, and the bolt 99 (coupling member) connected to the distal end portion of the lock pin 92a inserted into the through hole 98. The step portion 98a projecting inward in the radial direction is formed in the through hole 98 according to this embodiment, but the step portion 98a is not essential. It is only necessary that the through hole 98 has an inner diameter larger than the outer diameter of the lock pin 92a, and the bolt 99 includes the head portion 99a having an outer diameter larger than the inner diameter of the through hole 98. With this structure, to manually detach the main body portion 5 from the tool attachment portion 6, when the lever 93 is pulled up, the lever 93 abuts against the head portion 99a of the bolt 99, and the lock pin 92a can be pulled up integrally with the lever 93. On the other hand, when detaching the main body portion 5 from the tool attachment portion 6 by energizing the solenoid 12, movement of the lock pin 92a by the magnetic force of the electromagnet 91 is never impeded by the lever 93.

The robot tool exchange device 1 according to the above-described embodiment employs a configuration in which the air passage forming members 22 and 23 are provided in the main body portion 5, the air passage forming members 42 and 43 are provided in the tool attachment portion 6, and an air-driven tool can be used as the tool 4. However, if an electric tool is used as the tool 4, the air passage forming members 22, 23, 42, and 43 need not be provided. In this case, since air piping is not needed in the robot tool exchange device 1 or on the robot side, the structure can be simplified.

### INCORPORATION BY REFERENCE

This application claims the benefit of foreign priority to Japanese Patent Application No. JP2023-198267, filed Nov. 22, 2023, which is incorporated by reference in its entirety.

What is claimed is:

1. A robot tool exchange device comprising:
a main body portion attached to a robot arm; and
a tool attachment portion including a mounting seat to which a tool for the robot arm is attached, and detachably attached to the main body portion,
wherein the main body portion includes:
a solenoid including an electromagnet, and a plunger configured to move toward the robot arm by a magnetic force of the electromagnet, the plunger including a first portion on a side of the robot arm and a second portion on a side of the tool attachment portion;
a housing configured to store the second portion of the plunger;
a ball retractably held by the housing, the ball being configured to, when the plunger moves toward the tool attachment portion, be pressed by the plunger and project from the housing, and pressing by the plunger being canceled when the plunger moves toward the robot arm; and
a permanent magnet configured to move the plunger toward the tool attachment portion and hold the plunger when the electromagnet is non-excited,
the tool attachment portion includes a frame member in which a hole to receive the housing is formed, and
the frame member includes an engaging wall provided on a wall surface of the hole and configured to engage with the ball projecting from the housing and prevent the housing from coming off the hole.

2. The robot tool exchange device according to claim 1, wherein
the engaging wall includes a tilting surface that contacts the ball, and
the tilting surface gradually tilts, toward a radial center of the hole, to an opening edge of the hole.

3. The robot tool exchange device according to claim 1, wherein
the second portion of the plunger includes:
a large-diameter portion connected to the first portion;
a small-diameter portion having an outer diameter smaller than an outer diameter of the large-diameter portion; and
a tapered surface disposed between the large-diameter portion and the small-diameter portion and having an outer diameter that gradually becomes large from the small-diameter portion to the large-diameter portion.

4. The robot tool exchange device according to claim 1, wherein
the housing includes a ball holding portion configured to retractably hold the ball,
the ball holding portion includes a through hole extending between an inner peripheral surface of the housing facing the second portion of the plunger and an outer peripheral surface of the housing facing the frame member, and
the through hole includes a tapered surface having an inner diameter that gradually decreases toward the outer peripheral surface.

5. The robot tool exchange device according to claim 1, wherein
the electromagnet is formed into a cylindrical shape,
the plunger further includes an armature located on the same axis as the electromagnet, and
the permanent magnet is arranged at a position facing the armature.

6. The robot tool exchange device according to claim 5, wherein
the electromagnet includes:
a cylindrical electromagnetic coil; and
a cylindrical field core including an annular groove configured to open toward the armature and store the electromagnetic coil, and
the armature and the field core form a magnetic path.

7. The robot tool exchange device according to claim 6, wherein
the armature is configured to close the field core.

8. The robot tool exchange device according to claim 1, wherein
the electromagnet is formed into a cylindrical shape,
the first portion of the plunger includes a lock pin extending through an axis center of the electromagnet, and
the main body portion further includes a manual release lever connected to a distal end portion of the lock pin and configured to move the lock pin toward the robot arm.

9. The robot tool exchange device according to claim 8, wherein
a connecting portion between the lever and the lock pin includes:
a through hole formed in the lever and having an inner diameter larger than an outer diameter of the lock pin; and
a coupling member connected to the distal end portion of the lock pin inserted into the through hole and including a head portion having an outer diameter larger than the inner diameter of the through hole.
